(19) United States
(12) Patent Application Publication
(10) Pub. No.: US 2015/0336313 A1
(43) Pub. Date: Nov. 26, 2015

(54) VACUUM INJECTION MOLDING DEVICE AND INJECTION MOLDING METHOD USING SAME

(71) Applicant: Kil Nam JANG, (US)

(72) Inventor: Se Yoon OH, Changwon-si (KR)

(73) Assignee: Kil Nam JANG, Goyang-si (KR)

(21) Appl. No.: 14/409,844

(22) PCT Filed: Jun. 20, 2013
(86) PCT No.: PCT/KR2013/005429

§ 371 Date: Dec. 19, 2014

(30) Foreign Application Priority Data
Jun. 22, 2012 (JP) 10-2012-0067544

(51) Int. Cl. B29C 45/17; B29C 45/26; B29C 45/34

(52) U.S. Cl. CPC B29C 45/1701; B29C 45/34; B29C 45/2608

(57) ABSTRACT

A vacuum injection molding device according to an embodiment of the present invention includes: a first mold which is connected to an injection nozzle and is supplied with resin; a second mold which is coupled with the first mold so as to form an injection cavity; a fist seal member and a second seal member which surrounds an outer side of a contacting surface of the first mold and the second mold and faces one another to contact one another; and a vacuum pump which exhausts gas in the injection cavity so as to form a vacuum state in the injection cavity. A gas exhausting passage is provided to communicate with the injection cavity via one or more of the first seal member and the second seal member, and the vacuum pump exhausts the gas in the injection cavity via the gas exhausting passage.

### TECHNICAL FIELD

The present invention relates to a vacuum injection molding device of injecting high pressure gas into an injection cavity of vacuum state and subsequently injecting resin to form a product and an injection molding method using the same.

### BACKGROUND ART

Generally an injection molding device is one of plastic molding devices and is a mechanical device which heats and melts resin which has been dehumidified and dried and injects the resin into molds, and cools the resin to coagulate to form molded products.

In more detail, solid resin which is the raw material is melted using electrical heat, mechanical frictional heat, or the like, and the melted resin is injected into the molds which have desired shapes and is subsequently coagulated to form a formed product having a desired shape.

However, in such an injection molding device, while the resin goes through a plastication process of high temperature and is then injected into an injection cavity of atmospheric pressure, water is vaporized to obstruct flow of resin and adhesion of resin to molds so that surface characteristics may be deteriorated.

In order to solve this problem, there was a method of reducing water contained in resin. In more detail, a method of drying resin which will be used in an injection molding at high temperature for a long time was used.

However, for this method, a drying device which is specially manufactured is necessary, and this drying device causes high initial cost and also consumes substantial electricity so that manufacturing cost is increased and cost of the product is also increased.

Further, since the resin cannot be completely dried by the drying process by the drying device, water is evaporated during the forming process and this may cause the deformation of the exterior shape of the product and the quality problem.

Further, since foreign materials or gas may be remained in the molds which form the injection cavity due to repeated forming processes, the molds should be cleaned frequently and this increases maintenance cost and deteriorates the productivity.

### DETAILED DESCRIPTION OF THE INVENTION

### Technical Problem

The present invention has been made in an effort to provide a vacuum injection molding device which an injection cavity of atmospheric pressure is pressurized when the melted resin at high temperature is injected so as to prevent water in the resin from being evaporated and so as to remove foreign materials and gas inside the molds before the injection molding and so as to make the inside vacuum state, and the high-pressure gas is injected so that the molds and the molded product do not contact one another, thereby enhancing an exterior quality of the molded product, and an injection molding method using the same.

### Technical Solution

A vacuum injection molding device according to an embodiment of the present invention includes: a first mold which is connected to an injection nozzle and is supplied with resin; a second mold which is coupled with the first mold so as to form an injection cavity; a fist seal member and a second seal member which surrounds an outer side of a contacting surface of the first mold and the second mold and faces one another to contact one another; and a vacuum pump which exhausts gas in the injection cavity so as to form a vacuum state in the injection cavity. A gas exhausting passage is provided to communicate with the injection cavity via one or more of the first seal member and the second seal member, and the vacuum pump exhausts the gas in the injection cavity via the gas exhausting passage.

The first seal member and the second seal member may be fixed to the first mold and the second mold by a fixing clamp, and the fixing clamp may surround and tighten an outer surface of a contacting portion of the first seal member and the second seal member such that a contacting surface of the first seal member and the second seal member is sealed.

Portions of the first seal member and the second seal member which contact the molds may be made of urethane material which has heat-resisting characteristic and portions where the first seal member and the second seal member contact one another may be made of silicon material.

The vacuum injection molding device may further include a gas nozzle which is provided to the injection nozzle and injects high-pressure gas into the injection cavity via the injection nozzle.

The injection nozzle may include a head portion which is provided to communicate with the first mold, a body portion which is formed by being elongated along a length direction from the head portion, and a supplying pipe which is provided in a state of penetrating the head portion and the body portion. The gas nozzle may be provided between the head portion and the body portion to communicate with the supplying pipe.

The high-pressure gas may be air or carbon dioxide in a pressure between 30 bar and 40 bar.

The gas exhausting passage may be formed at one of the first seal member and the second seal member.

A injection molding method according to an embodiment of the present invention includes: combining a second mold to a first mold to form an injection cavity therein; removing foreign materials and gas in the injection cavity using a vacuum pump and then forming a vacuum in the injection cavity; injecting high-pressure gas into the injection cavity via a gas nozzle which is connected to an injection nozzle; injecting resin into the injection cavity via the injection nozzle; coagulating the resin injected into the injection cavity; and separating the coagulated resin from the first mold and the second mold to complete a molded product.

### Advantageous Effects

According to the present invention, since foreign materials and gas of the injection cavity are removed by the vacuum pump before the injection molding, it is possible to increase the period for cleaning the molds so that the maintenance cost can be reduced and the productivity can be enhanced.

Further, since the injection cavity is maintained in a vacuum state, the effects of the holding pressure and the cooling during the forming of the molded product can be obtained.

Further, since the injection cavity in a state of atmospheric pressure is pressurized to a predetermined pressure so that the evaporation of water is suppressed while the resin is injected, the quality of the exterior of the product can be enhanced and the regenerants can be reused without using the dehumidifier and the drier so that the manufacturing cost can be reduced.

Further, since the gas is injected via the gas nozzle which is connected to the injection nozzle instead of separate gas passage in the molds in order to inject gas into the injection cavity, the working processes can be reduced and the working performance and the productivity can be enhanced.

### BRIEF DESCRIPTION OF DRAWINGS

FIG. 1 is a sectional view of schematically showing a vacuum injection molding device according to an embodiment of the present invention.

FIG. 2 is a sectional view of molds of a vacuum injection molding device to which a first seal member and a second seal member according to an embodiment of the present invention have been applied.

FIG. 3 is a sectional view of a portion in which a gas nozzle of a vacuum injection molding device according to an embodiment of the present invention.

FIG. 4 is a flowchart for explaining an injection molding method using a vacuum injection molding device according to an embodiment of the present invention.

### EXPLANATIONS OF REFERENCE NUMERALS

1: vacuum injection molding device
101: first mold
1011: fixed side plate
1013: tie bar
1015: injection hole
103: second mold
1031: moving side plate
1033: cooling water passage
105: injection cavity
30: hopper
50: injection nozzle
501: head portion
503: body portion
505: supplying pipe
70: melting device
90: screw
110: first seal member
130: second seal member
150: fixing clamp
170: vacuum pump
190: gas nozzle
210: urethane material
230: silicon material
300: gas exhausting passage
S100: injection molding method using vacuum injection molding device

### DETAILED DESCRIPTION OF THE EMBODIMENTS

Embodiments of the present invention will be explained in detail with reference to the accompanying drawings hereinafter.

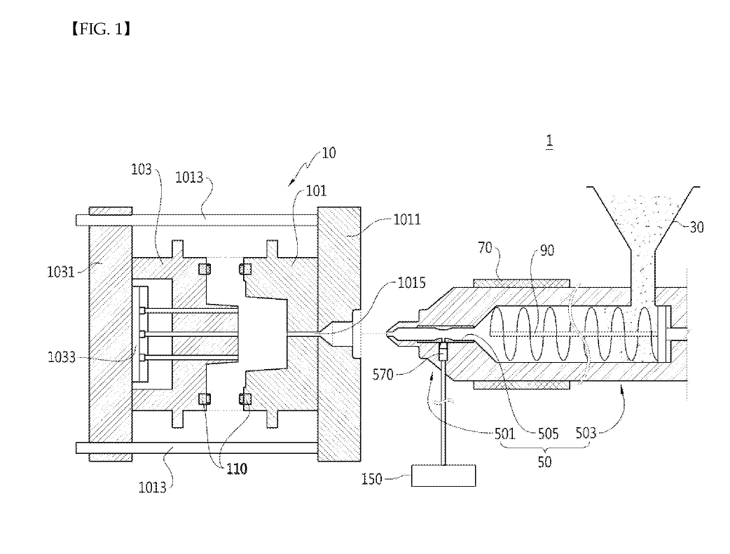

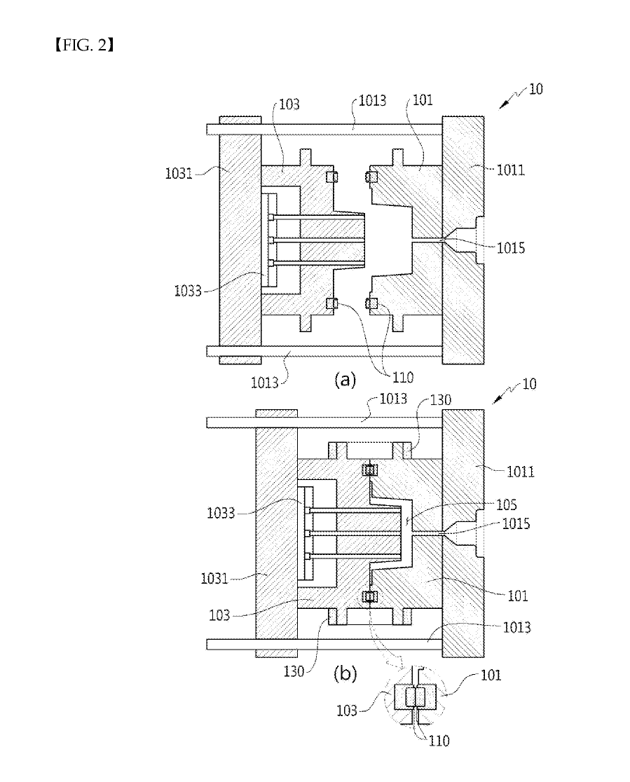

FIG. 1 is a sectional view of schematically showing a vacuum injection molding device according to an embodiment of the present invention, and FIG. 2 is a sectional view of molds of a vacuum injection molding device to which a first seal member and a second seal member according to an embodiment of the present invention have been applied.

Referring to FIG. 1 and FIG. 2, a vacuum injection molding device 1 (hereinafter called ‘vacuum injection molding device 1’) according to an embodiment of the present invention is an injection molding device which injects melted resin in an injection cavity 105 which is formed inside molds and cools and coagulates (solidifies) to form a molded product, and includes a first mold 101 and a second mold 103.

In more detail, the vacuum injection molding device 1 includes the first mold 101 which is connected to an injection nozzle 50 to be supplied with resin and the second mold 103 which is coupled with the first mold 101 to form the injection cavity 105 therein.

Exemplarily, the first mold 101 of the vacuum injection molding device 1 may be a fixed mold and the second mold 103 may be a moving mold. At this time, the fixed mold may be a mold which receives melted resin and forms one side of an outer portion of a molded product and the moving mold may be a mold which is coupled to the fixed mold, i.e., the first mold 101 to form the other side of an outer portion of a molded product. In more detail, the first mold 101 is mounted to a fixed side plate 1011 and is supplied with resin from a hopper 30 to form one side of an outer portion of a molded product, and the second mold 103 is mounted to a moving side plate 1031 which moves along a tie bar 1013 of the fixed side plate 1011 and is coupled with the first mold 101 to form the other side of an outer portion of a molded product. At this time, a coupled inner surface of the first mold 101 which is mounted to the fixed side plate 1011 and the second mold 103 which is mounted to the moving side plate 1031 may form the injection cavity 105 which receives the melted resin through the injection nozzle 50 and forms a molded product. In addition, an injection hole 1015 through which resin is supplied into the injection cavity 105 from the hopper 30 may be formed in the first mold 101, a cooling water passage 1033 which cools and solidifies the resin injected into the injection cavity 105 may be formed in the second mold 103.

Further, the vacuum injection molding device 1 includes a first seal member 110 and a second seal member 130. In more detail, the vacuum injection molding device 1 includes a first seal member 110 and a second seal member 130 which are faced one another to contact one another in a state of surrounding an outer side of a contacting portion where the first mold 101 and the second mold 103 contact one another.

Exemplarily, referring to FIG. 1 and FIG. 2, the first seal member 110 and the second seal member 130 may be formed of double-material. Here, the double-material may be formed different materials according to applied positions. In more detail, the first seal member 110 and the second seal member 130 may be made of urethane material 210 which has heat-resisting characteristic at portions contacting the molds and the first seal member 110 and the second seal member 130 may be made of silicon material 230 at portions contacting one another. However, the structures for connecting to the first mold 101 and the second mold 103, shapes, materials and the like thereof may be varied depending on requirements in usages.

In addition, a gas exhausting passage 300 which communicates with an injection cavity 105 through at least one of the first seal member 110 and the second seal member 130 is provided. For example, the gas exhausting passage 300 may be formed to at least one of the first seal member 110 and the second seal member 130.

Referring to FIG. 1 and FIG. 2, the gas exhausting passage 300 may be formed to communicate with the injection cavity 105 so as to exhaust gas in the injection cavity 105 which is formed by the coupling of the first mold 101 and the second mold 103 using a vacuum pump 170.

In addition, referring to FIG. 1 and FIG. 2, the first seal member 110 and the second seal member 130 of the vacuum injection molding device 1 may be fixed by a fixing clamp 150.

Exemplarily, the first seal member 110 and the second seal member 130 which are disposed at a periphery of the first mold 101 and the second mold 103 to contact one another in a state of facing one another are fixed by the fixing clamp 150 which is formed to surround and tighten the outer surface of the contacting portion of the first seal member 110 and the second seal member 130 such that the contacting surface of the first seal member 110 and the second seal member 130 is sealed.

In addition, referring to FIG. 1 and FIG. 2, the vacuum injection molding device 1 includes the vacuum pump 170 to form vacuum state in the injection cavity 105 by exhausting gas inside the injection cavity 105.

The vacuum pump 170 exhausts gas inside the injection cavity 105 through the gas exhausting passage 300 to form vacuum in the injection cavity 105.

Exemplarily, the vacuum pump 170 is connected to the gas exhausting passage via a tube and exhausts gas in the injection cavity 105 using suction function of the pump. Further, the vacuum pump 170 may also perform the function of removing substances remaining in the injection cavity 105 due to repeated operations using the suction function. However, the vacuum pump 170 may be substituted by various devices and methods which can perform the same function.

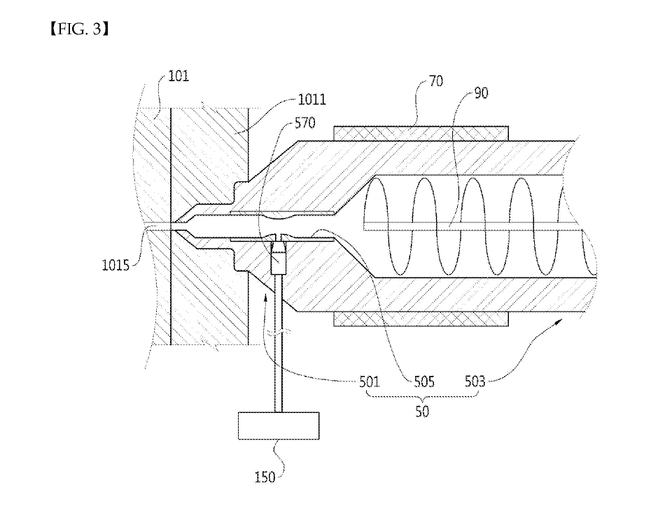

FIG. 3 is a sectional view of a portion where a gas nozzle 190 of the vacuum injection device 1 has been applied.

Referring to FIG. 3, the vacuum injection molding device includes the gas nozzle 190. In more detail, the gas nozzle 190 is provided to the injection nozzle 50 and injects high-pressure gas to the injection cavity 105 through the injection nozzle 50.

As an example, the injection nozzle 50 may include a head portion 501 which is provided to communicate with the first mold 101, a body portion 503 which elongates from the head portion 501 along a longitudinal direction, and a supplying pipe 505 which is formed to penetrate the head portion 501 and the body portion 503 and through which melted resin is supplied. The gas nozzle 190 is connected to the supplying pipe 505 between the head portion 501 and the body portion 503 of the injection nozzle 50. At this time, a portion of the supplying pipe 505 between the head portion 501 and the body portion 503 may be formed in a shape of Venturi pipe an inner diameter of which becomes smaller and then becomes larger. At this time, the supplying pipe 505 may have a shape which is able to enhance flowing of resin by causing pressure difference in the supplying pipe 505, that is, a shape which both ends are wide and a center portion is narrow. The gas nozzle 190 is connected to a center portion of the supplying pipe 505 having a shape of Venturi pipe. According to this structure, when resin passes the supplying pipe 505 of a shape of Venturi pipe, the speed of resin rapidly increases and at the same time the pressure rapidly decreases (Bernoulli's theorem: an increase in the speed of the fluid occurs simultaneously with a decrease in pressure, and to the contrary a decrease in the speed of the fluid occurs simultaneously with an increase in pressure), so resin and gas can be evenly mixed. At this time, the high-pressure gas which is supplied from the gas nozzle 190 may be air or carbon dioxide having a pressure between 30 bar and 40 bar. However, this may be varied depending on the necessity of usage.

In addition, a control unit (not shown) may be provided outside the gas nozzle 190.

Exemplarily, the gas nozzle 190 may inject high-pressure gas into the injection cavity 105 of the vacuum injection molding device according to control instruction of the control unit so as to play a role of pressurizing the injection caviry 105. Accordingly, the control unit may include driving devices for performing functions for allowing the gas nozzle 190 to play this role and a controller for controlling these devices. However, the control unit may include units for overall control of the vacuum injection molding device 1 instead of being limited to the control of the gas nozzle 190, and this can be varied depending on the necessity of usages.

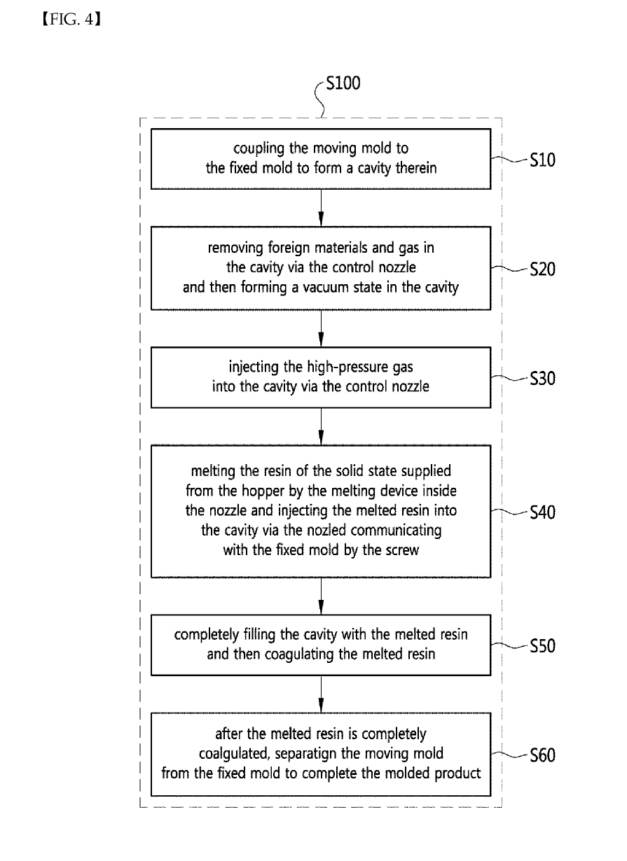

Meanwhile, FIG. 4 is a flow chart for explaining the injection molding method S100 using the vacuum injection molding devices 1.

Hereinafter, an injection molding method S100 (hereinafter referred to as the injection molding method S100) using the above-mentioned vacuum injection molding device 1 will be described. For the parts of the vacuum injection molding device 1, the same references numerals will be used in the description of the injection molding method S100, and description for the same or similar parts will be made briefly or omitted.

Referring to FIG. 1 and FIG. 4, the injection molding method S100 includes a step S10 that the second mold 103 is coupled to the first mold 101 so as to form the injection cavity 105 therein.

If the moving side plate 1031 moves toward the fixed side plate 101 along the tie bar 1013, the second mold 103 is coupled to the first mold 101 so that the space in which the molded product is formed, i.e., the injection cavity 105 is formed.

Subsequently, the injection molding method S100 includes a step S20 of removing foreign materials and gas of the injection cavity 105 and then forming a vacuum state in the injection cavity 105 using the vacuum pump.

The injection cavity 105 which is formed by the coupling of the second mold 103 and the first mold 101 and the vacuum pump 170 which is connected to the gas exhausting passage 300 which is formed in the seal member through pipe so as to communicate with the injection cavity 105, so the foreign materials and gas of the injection cavity 105 are removed and vacuum state is formed.

Subsequently, the injection molding method S100 includes a step S30 of injecting high-pressure gas into the injection cavity 105 via the gas nozzle 190 which is connected to the injection nozzle 50.

Exemplarily, the high-pressure gas injected into the injection cavity 105 may play a role of a cushion which the outer surface of the molded product does not directly contact the inner surface of the injection cavity 105.

Subsequently, the injection molding method S100 includes a step S40 of injecting resin into the injection cavity 105 via the injection nozzle 50.

The resin of the solid state supplied from the hopper 30 is melted by the melting device 70 inside the injection nozzle 50 and the melted resin is injected into the injection cavity 105 via the injection nozzle 50 communicating with the first mold 101 by the screw 90. In more detail, while the screw 90 which is provided at a center portion of the injection nozzle 50 rotates to move the resin of the solid state supplied from the hopper 30 toward the first mold 101. At this time, the resin of the solid state is melted by the melting device 70 which is provided at the periphery of the injection nozzle 50 and is then injected into the injection cavity 105 by the pressure produced by the rotation of the screw 90.

Subsequently, the injection molding method S100 includes a step S50 of coagulating the resin injected into the injection cavity 105.

If the injection cavity 105 is completely filled with the resin, the cooling water is supplied to the cooling water passage 1033 which is formed in the second mold 103 so that the resin is coagulated.

Finally, the injection molding method S100 includes a step S60 of separating the coagulated resin from the first mold 101 and the second mold 103 to complete the molded product.

If the resin injected into the injection cavity 105 is completely coagulated, the moving side plate 1031 moves backward so that the second mold 103 is separated from the first mold 101 so as to form the molded product.

As such, since the foreign materials and gas are removed from the injection cavity 105 by the vacuum pump before the injection molding, the period of cleaning the molds can be increased so that the maintenance cost can be reduced and the productivity can be enhanced.

In addition, since the injection cavity 105 can be maintained in the vacuum state, the effects of the holding pressure and the cooling during the forming of the molded product can be obtained.

In addition, since the injection cavity 105 in a state of atmospheric pressure is pressurized to a predetermined pressure so that the evaporation of water is suppressed while the resin is injected, the quality of the exterior of the product can be enhanced and the regenerants can be reused without using the dehumidifier and the drier so that the manufacturing cost can be reduced.

Further, since the gas is injected via the gas nozzle 190 which is connected to the injection nozzle 50 instead of separate gas passage in the molds in order to inject gas into the injection cavity 105, the working processes can be reduced and the working performance and the productivity can be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention relates to a vacuum injection molding device and method and can be applied to the injection molding for various products, so the present invention has an industrial applicability.

1. A vacuum injection molding device comprising:
a first mold which is connected to an injection nozzle and is supplied with resin;
a second mold which is coupled with the first mold so as to form an injection cavity;
a fist seal member and a second seal member which surrounds an outer side of a contacting surface of the first mold and the second mold and faces one another to contact one another; and
a vacuum pump which exhausts gas in the injection cavity so as to form a vacuum state in the injection cavity,
wherein a gas exhausting passage is provided to communicate with the injection cavity via one or more of the first seal member and the second seal member, and
wherein the vacuum pump exhausts the gas in the injection cavity via the gas exhausting passage.

2. The vacuum injection molding device of claim 1, wherein the first seal member and the second seal member are fixed to the first mold and the second mold by a fixing clamp, and the fixing clamp surrounds and tightens an outer surface of a contacting portion of the first seal member and the second seal member such that a contacting surface of the first seal member and the second seal member is sealed.

3. The vacuum injection molding device of claim 1, wherein portions of the first seal member and the second seal member which contact the molds are made of urethane material which has heat-resisting characteristic and portions where the first seal member and the second seal member contact one another are made of silicon material.

4. The vacuum injection molding device of claim 1, further comprising a gas nozzle which is provided to the injection nozzle and injects high-pressure gas into the injection cavity via the injection nozzle.

5. The vacuum injection molding device of claim 4, wherein the injection nozzle comprises a head portion which is provided to communicate with the first mold, a body portion which is formed by being elongated along a length direction from the head portion, and a supplying pipe which is provided in a state of penetrating the head portion and the body portion, wherein the gas nozzle is provided between the head portion and the body portion to communicate with the supplying pipe.

6. The vacuum injection molding device of claim 4, wherein the high-pressure gas is air or carbon dioxide in a pressure between 30 bar and 40 bar.

7. The vacuum injection molding device of claim 1, wherein the gas exhausting passage is formed at one of the first seal member and the second seal member.

8. A injection molding method comprising:
combining a second mold to a first mold to form an injection cavity therein;
removing foreign materials and gas in the injection cavity using a vacuum pump and then forming a vacuum in the injection cavity;
injecting high-pressure gas into the injection cavity via a gas nozzle which is connected to an injection nozzle;
injecting resin into the injection cavity via the injection nozzle;
coagulating the resin injected into the injection cavity; and
separating the coagulated resin from the first mold and the second mold to complete a molded product.
